(19) United States
(12) Patent Application Publication
(10) Pub. No.: US 2023/0282110 A1
(43) Pub. Date: Sep. 7, 2023

(54) System and Method for Alerting Drivers of Approaching Construction Zone on a Roadway

(71) Applicant: Rob Schwear, Midlothian, VA (US)

(72) Inventor: Rob Schwear, Midlothian, VA (US)

(21) Appl. No.: 17/938,158

(22) Filed: Oct. 5, 2022

Related U.S. Application Data
(60) Provisional application No. 63/315,554, filed on Mar. 2, 2022.

(51) Int. Cl. G08G 1/0967

(52) U.S. Cl. CPC G08G 1/096783

(57) ABSTRACT

The present invention relates to a GPS-based safety system designed for improving safety for construction workers and employees inside a construction zone or work zone on a roadway. The system includes a software application configured to be installed in a user device for displaying a push notification and playing an audio alert for alerting the driver of a vehicle to reduce the speed of the vehicle. The notifications are provided when the vehicle in which the user device is positioned approaches a construction zone and is within a predetermined distance from the construction zone. One or more GPS transmitter devices are positioned near the construction site and a determination of distance between the vehicle and the GPS transmitter device is performed wherein the location of the user device is determined using GPS satellites. The notifications may include an instruction message to reduce the speed of the vehicle.

### CROSS-REFERENCE TO RELATED APPLICATION

The present application claims priority to, and the benefit of, U.S. Provisional Application No. 63/315,554, which was filed on Mar. 2, 2022, and is incorporated herein by reference in its entirety.

### FIELD OF THE INVENTION

The present invention relates generally to the field of safety systems and global positioning systems. More specifically, the present invention relates to a GPS-based system that alerts drivers of upcoming work zones and speed restrictions on a roadway. The system provides notifications on an electronic device in which a software application is installed. A plurality of transmitters is positioned on the roadways for determining distance of a user device from a construction site and based on the determined distance, notifications are provided for slowing down the vehicle. Accordingly, the present disclosure makes specific reference thereto. Nonetheless, it is to be appreciated that aspects of the present invention are also equally applicable to other similar to applications, devices, and methods of manufacture.

### BACKGROUND

By way of background, roadways including nation's highways, roads, and streets require periodic construction and maintenance work. For performing these tasks, commonly, roadways are not completely blocked (i.e., closed) to avoid inconvenience to individuals. Typical maintenance work includes clearing debris from the work site, using jackhammers to break up existing roadways and tending equipment such as cement mixers and/or asphalt heaters. For safety of these workers and for warning motorists and controlling flow of traffic, cones, signs, and barricades are installed which act as flagmen to stop or direct traffic. However, such methods are ineffective as these are not proactive and motorists see them upon the same time as nearly reaching the construction or maintenance site. When vehicles are in high speed, it is almost impossible to reduce speed or stop the vehicle, which may cause injury to the construction workers and also for the passengers of the vehicle and other vehicles. Some drivers may ignore signs or not see them entirely, increasing the risk of accident and injury.

Many roadways have speed restricted areas or regions and warning signs are put in place for alerting drivers. However, such signs are ignored or missed which causes risk of an accident for individuals. As a result, individuals desire a more effective method of alerting motorists about an approaching construction work zone or speed restricted area.

Placing warning signs ahead of and around construction sites is difficult to install and remove and further takes space on a roadway. Also, considerable effort is spent on building warning signs. It would be desirable to have a system that can alert a driver/user of a reduced speed area without a user requiring to look for warning or diversion signals.

Therefore, there exists a long-felt need in the art for an improved way to alert drivers and motorists of approaching construction work zones and speed restricted areas. There is also a long-felt need in the art for safety systems for roadway construction and maintenance workers that does not depend solely on physical warning signs. Additionally, there is a long-felt need in the art for an improved way of alerting drivers that alerts them about approaching construction work zones and speed restricted areas well before reaching the site. Moreover, there is a long-felt need in the art for a safety system that prevents motorists from speeding through work zones. Further, there is a long-felt need in the art for an alert system that alerts drivers and motorists by providing audible and visual notifications on their smartphones. Finally, there is a long-felt need in the art for a safety system that properly alerts drivers of the oncoming work zone and improves safety for the construction workers and employees inside the zone.

The subject matter disclosed and claimed herein, in one embodiment thereof, comprises of a GPS-based safety system for improving safety for the construction workers and employees inside a construction zone or work zone on a roadway. The system features a software application installed in a user device and is configured to display a push notification alerting a driver of a vehicle for slowing down a speed of the vehicle when the vehicle in which a user device is positioned approaches a construction zone. One or more GPS transmitter devices are positioned near the construction site and a determination of distance between the vehicle and the GPS transmitter device is performed and the push notification is generated when the distance is less than a predetermined threshold. The push notification may include an instruction message for slowing down and a reason for slowing down the vehicle. Additionally, an audible alert is also generated for ensuring that the driver is aware of the zone and can slow down to a proper speed.

In this manner, the safety system and associated method of the present invention accomplishes all of the forgoing objectives and provides users a GPS-based software application capable of warning drivers of an approaching construction work zone. An audible warning of the approaching work helps in improving safety for the construction workers and employees. The system reduces work zone injuries and fatalities by ensuring that the driver is aware of the reduced speed zone and can slow down to a proper speed.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a GPS-based safety system for improving safety for the construction workers and employees inside a construction zone or work zone on a roadway. The system is designed to alert drivers about upcoming work zones and/or speed restrictions on the roadway. The system includes a software application installed in a user device for displaying a push notification alerting the driver of a vehicle for slowing down the speed of the vehicle. The push notification is provided when the vehicle in which the user device is positioned approaches a construction zone. One or more GPS transmitter devices are positioned near the construction site and a determination of distance between the vehicle and the GPS transmitter device is performed wherein the location of the user device is determined using GPS satellites such that the push notification is generated when the distance is less than a predetermined threshold. The push notification may include an instruction message for slowing down and a reason for slowing down the vehicle. Additionally, an audible alert is also generated for ensuring that the driver is aware of the zone and can slow down to a proper or designated speed.

In yet another embodiment, a method for alerting a user for slowing down a vehicle upon approaching a construction site or a speed restricted region on a roadway is described. The method comprising the steps of determining, by a position module of a user device, location of the user device; the user device is carried by the user while travelling in the vehicle; determining, by a position module of a GPS transmitter device, location of the GPS transmitter device; the GPS transmitter device is positioned at the onset of the construction site or speed restricted region; determining a distance between the user device and the GPS transmitter device; comparing the determined distance with a predetermined distance threshold; displaying a push notification on the user device when the determined distance is less than the predetermined distance threshold wherein the notification indicates an instruction for slowing down a speed of the vehicle to enhance safety of construction workers and employees inside the construction zone.

In yet another embodiment, a method for alerting a user for slowing down a vehicle upon approaching a construction site or a speed restricted region on a roadway is described. The method comprising the steps of determining, by a position module of a user device, location and speed of the user device; the user device is carried by the user while travelling in the vehicle; determining, by a position module of a GPS transmitter device, a location of the GPS transmitter device; the GPS transmitter device is positioned at the onset of the construction site or speed restricted region; determining a distance between the user device and the GPS transmitter device; comparing the determined distance with a predetermined distance threshold; comparing speed of the user device with a predetermined speed threshold when the determined distance is less than the predetermined distance threshold, displaying a push notification on the user device when the speed of the user device is greater than the predetermined speed threshold wherein the notification indicates an instruction for slowing down the speed of the vehicle to enhance safety of construction workers and employees inside the construction zone.

In a further embodiment of the present invention, the location of the user device is determined using Wi-Fi beacons transmitted by the GPS transmitter device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one potential embodiment of a roadway safety system of the present invention in accordance with the disclosed architecture;

FIG. 2 illustrates a flow diagram depicting a process of sending a push notification to the software application for alerting a driver to slow down a speed of a vehicle in accordance with the disclosed architecture;

FIG. 3 illustrates a flow diagram showing a determination of the conditions based on which push notifications are sent for slowing down the speed of the vehicle in accordance with the disclosed architecture;

FIG. 4 illustrates a schematic view showing use of Wi-Fi signals for direct interaction of GPS transmitter devices and software application in accordance with the disclosed architecture;

FIG. 5 illustrates a functional block diagram of a GPS transmitter device used at a construction site or work zone on a roadway in accordance with the disclosed architecture;

FIG. 6 illustrates a perspective view showing an exemplary push notification displayed on the user device for alerting a driver in accordance with the disclosed architecture;

FIG. 7 illustrates a perspective view showing use of the construction site safety system of the present invention in accordance with the disclosed architecture; and

FIG. 8 illustrates components of the exemplary user device for installing the software application in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved way to alert drivers and motorists of approaching construction work zones and speed restricted areas. There is also a long-felt need in the art for safety systems for roadway construction and maintenance workers that does not depend only on physical warning signs. Additionally, there is a long-felt need in the art for an improved way of alerting drivers about approaching construction work zones and speed restricted areas well before reaching the site. Moreover, there is a long-felt need in the art for a safety system that prevents motorists from speeding through work zones. Further, there is a long-felt need in the art for an alert system that alerts drivers and motorists by providing audible and visual notifications on their smartphones. Finally, there is a long-felt need in the art for a safety system that properly alerts drivers of the oncoming work zone and improves safety for the construction workers and employees inside the zone.

The present invention, in one exemplary embodiment, is a novel method for alerting a driver/user for reducing a vehicle speed upon approaching a construction site or a speed restricted region on a roadway. The method uses a position module of a user device to determine location and speed of the user device; the user device is carried by the user while travelling in the vehicle; determine location of the GPS transmitter device wherein the GPS transmitter device is positioned at the onset of the construction site or speed restricted region. Then a distance between the user device and the GPS transmitter device is determined and is compared with a predetermined distance threshold. Speed of the user device is compared with a predetermined speed threshold when the determined distance is less than the predetermined distance threshold. A push notification on the user device is displayed when the speed of the user device is greater than the predetermined speed threshold wherein the notification indicates an instruction for slowing down the speed of the vehicle to enhance safety of construction workers and employees inside the construction zone.

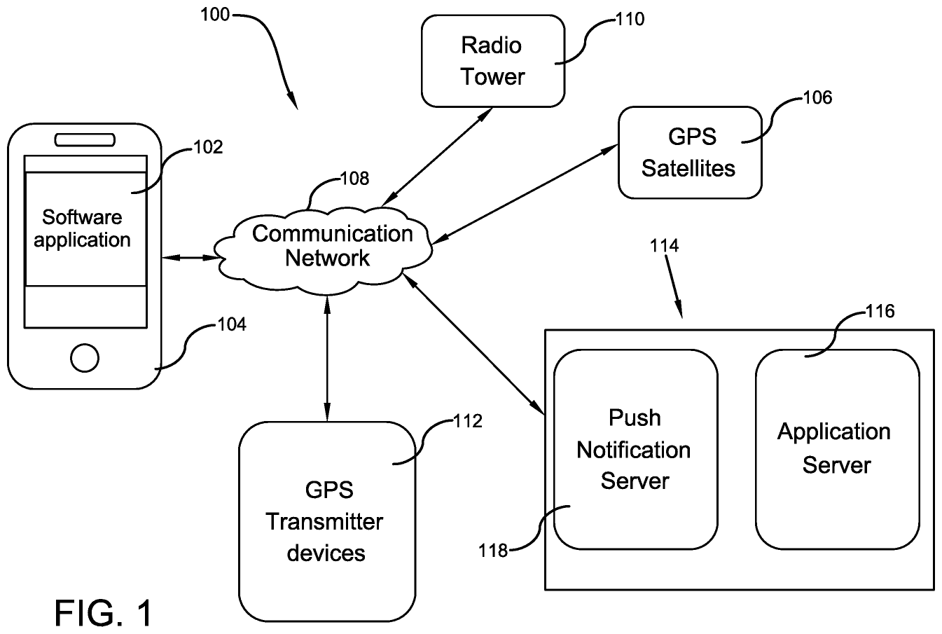

Referring initially to the drawings, FIG. 1 illustrates a schematic view of one potential embodiment of roadway safety system of the present invention in accordance with the disclosed architecture. The roadway safety system 100 of the present invention is configured to alert drivers of upcoming work zones and speed restrictions on a roadway for enhancing roadway safety for all workers that work on highways or in high-speed travel areas. More specifically, the system 100 uses GPS technology for identifying current location of a driver/vehicle and a work zone area being approached by the driver during travel and accordingly, a push notification is sent on a computer implemented software application installed in a handheld electronic device or alternatively can be displayed on a display device of a vehicle for slowing down speed of the vehicle.

The system 100 uses the computer implemented positioning application 102 installed in the electronic device 104 wherein the application 102 uses positioning module of the electronic device for determining location of the device 104. The application 102 may be configured to display a map indicating a current location of the user/vehicle and receives location information from the GPS satellites 106 via a communication network 108. In addition to receiving location information from GPS satellites 106, the system 100 uses radiolocation technique where the approximated location of the device 104 corresponds to a range of locations corresponding to a transmission range of a single radio tower 110.

GPS location determination may be performed by the user's device 104 receiving time signals sent from global positioning satellites 106, which are received and processed by the mobile device to estimate its position by performing a triangulation process of signals received from three or more global positioning satellites, in a manner known to those of ordinary skill in the art.

In one exemplary embodiment of the present invention, the radio tower 110 is assigned a unique identification number, a radio Cell-ID. The radio Cell-ID is received by the mobile device 104 when in the coverage area of the radio tower 110, thus the position of the device 104 in the coverage area of the radio tower 110 is derived from the coordinates of the radio tower 110. It should be appreciated that the location of the user device 104 can be determined using any one or both GPS technology and radiolocation technology.

By way of example, and without intending to limit the present disclosure, the location of the vehicle/user device 104 may describe through the use of coordinates such as geographic coordinates (e.g., longitude/latitude coordinates) or Cartesian coordinates (e.g., the selection of n-coordinates for an n-dimensional Euclidean space). In the present embodiment, the communication network 108 may comprise satellite network allowing transmission of GPS coordinates, cellular network, public network, and more.

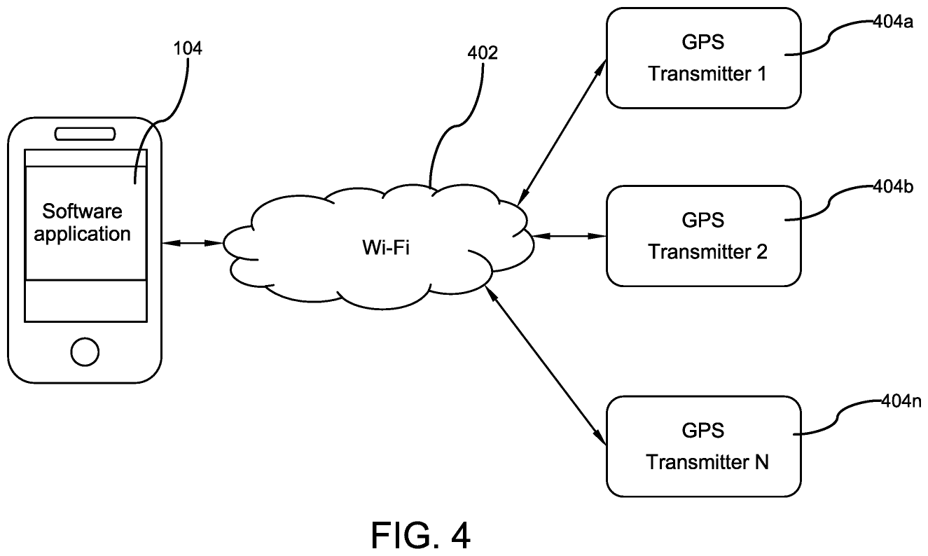

For detecting accurate location and position of work zones and other sensitive areas on a roadway, the system 100 uses GPS transmitters 112 positioned near the work zones. One or more GPS transmitters 112 can be removably or permanently positioned on the roadways and are configured to transmit their location using a positioning module as described in FIG. 4. The location of the transmitter devices 112 are used for determining the distance of an approaching user device/vehicle to the work zone for which the GPS transmitter 112 is positioned. The transmitter devices 112 may also function as Wi-Fi access points for transmitting Wi-Fi beacons directly to the nearby user devices.

The system 100 also uses a server system 114 for providing required functionality and insights to the software application 102 allowing the safety of roadway workers from speeding vehicles. An application server 116 is configured to provide necessary user interface, map display, insights, and more to a user. The application server 116 may be a computing device configured to offer any desired service and may run various languages and operating systems (e.g., servlets and JSP pages running on Tomcat/MySQL, OSX, BSD, Ubuntu, Redhat, HTMLS, JavaScript, AJAX, and COMET). The application server 116 may also be configured to collect user paths and may be used for providing alternate paths, advertisements, and recommendations. The application server 116 is configured to format information in a relevant format for display in software application 102.

A push notification server 118 is configured to provide push notifications to the software application 102 based on the location information of the user device 104 and the GPS transmitter devices 112. It should be appreciated that the server system 114 receives real time information on location of the user device and GPS transmitter device, including both the GPS location and radiolocation.

The system 100 can be implemented in a city, state, country and even globally where the location of the user devices is tracked and are provided with information about approaching work zones. It should be noted that the GPS transmitter devices 112 can be positioned at a different location, such as, a specific speed restriction zone thereby alerting a driver to slow down a vehicle speed upon approaching the speed restriction zone. The electronic device 104 can be any wireless device such as wireless laptops and netbooks, mobile phones, mobile televisions, personal digital assistants (PDA), etc., and can be any other desired device. The electronic device 104 can be in the form of an automotive display device embedded in a vehicle. The system 100 may register a user and/or the user's devices (e.g., a mobile device, such as a cell phone) for location services. The computing device can also generate and/or store a user profile including the user's current location.

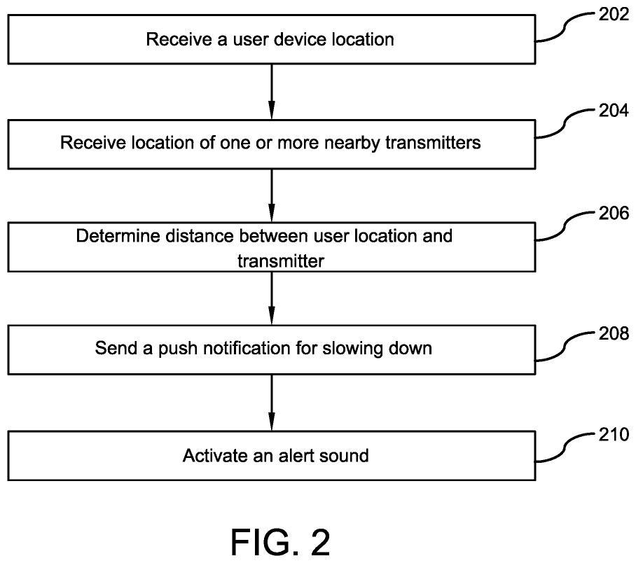

FIG. 2 illustrates a flow diagram depicting a process of sending a push notification to the software application for alerting a driver to slow down a speed of a vehicle in accordance with the disclosed architecture. Initially, location of a user device in which the computer implemented safety software application 102 is determined using GPS, radiolocation, and/or beacon technology (Step 202). The user device is preferably in a vehicle driving on a roadway. Simultaneously, location of the GPS transmitter devices on the roadway are received by the system (Step 204). Based on the received locations, real time distance between the user device and the transmitter device is measured using the server system (Step 206) and accordingly, a push notification is sent to the application 102 for slowing down the speed of the vehicle (Step 208). In addition to sending a push notification, the application 102 activates an audible alert sound on the user device thereby allowing a driver to receive an audible alert (Step 210).

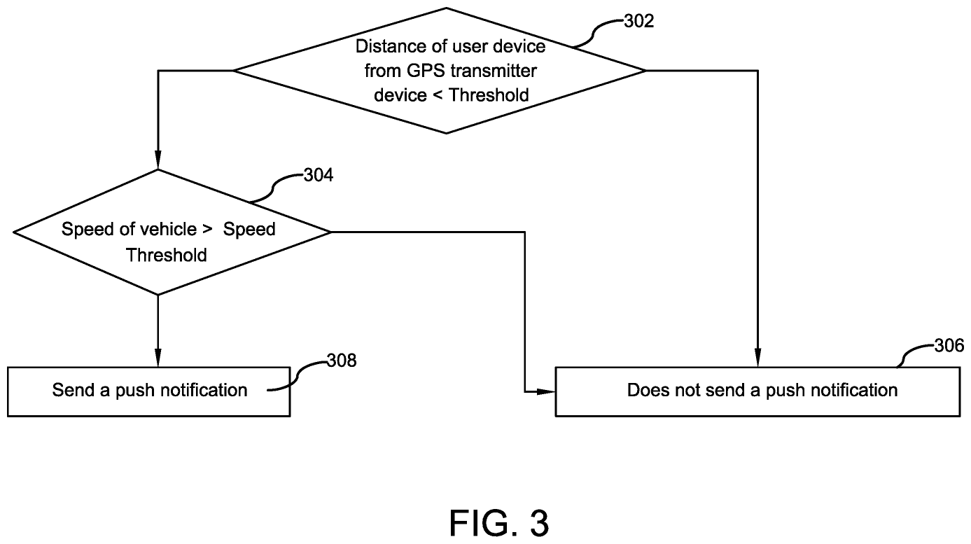

FIG. 3 illustrates a flow diagram showing determination of the conditions based on which push notifications are sent for slowing down speed in accordance with the disclosed architecture. As illustrated, initially, distance of the user device from a construction site/work zone is determined wherein one or more GPS transmitter devices are positioned near the construction site and is compared to a predetermined threshold (Step 302). The threshold can be automatically predefined by the server system of the present invention or alternatively can be set by a user using the software application. In one embodiment, the threshold can be 200 meters or can be 300 meters. If a vehicle distance is less than or equal to the predetermined threshold, then, speed of the vehicle/user device is detected and is compared to a speed threshold (Step 304). If the vehicle distance is more than the predetermined threshold, then, no push notification is transmitted (Step 306).

At step 304, if the speed of the user device/vehicle is found to be more than a speed threshold, then a push notification is generated for alerting a driver to slow down the speed of the vehicle (Step 308). If the speed is less than the speed threshold, then, the push notification is not sent to the software application installed in the user device.

It should be appreciated that the present invention ensures that a push notification, along with the audible alert, is sent when a vehicle approaches a construction site with a high speed. For example, if a vehicle is running/moving at a low speed such as 10 km/hr, then, only a notification of a construction site may be provided without notifying a driver to slow speed of the vehicle.

In some embodiments of the present invention, the push notification for slowing down speed is displayed on the software application irrespective of speed of the user device/vehicle and in such cases, only distance of the vehicle/user device from the construction site is determined. The positioning module or GPS module of the user device may calculate or extrapolate the speed of the vehicle based upon how far the vehicle has moved during a given time interval (i.e., mph).

FIG. 4 illustrates a schematic view showing use of Wi-Fi signals for direct interaction of GPS transmitter devices and software application in accordance with the disclosed architecture. The GPS transmitter devices 404a-n are also configured to function as Wi-Fi access points which transmit Wi-Fi beacon signals 402 that are received by user devices within Wi-Fi range of the transmitter devices 404a-n. The transmitter devices 404a-n refer to the GPS transmitter device 112 of FIG. 1. The received Wi-Fi signals 402 are processed by the user device to estimate their position based on known Wi-Fi access point locations. This is useful for cases where GPS may not work due to inclement weather, unavailability of network, and more. In some embodiments, the Wi-Fi may be used with the GPS functionality and cellular network for determining an accurate location of the user device.

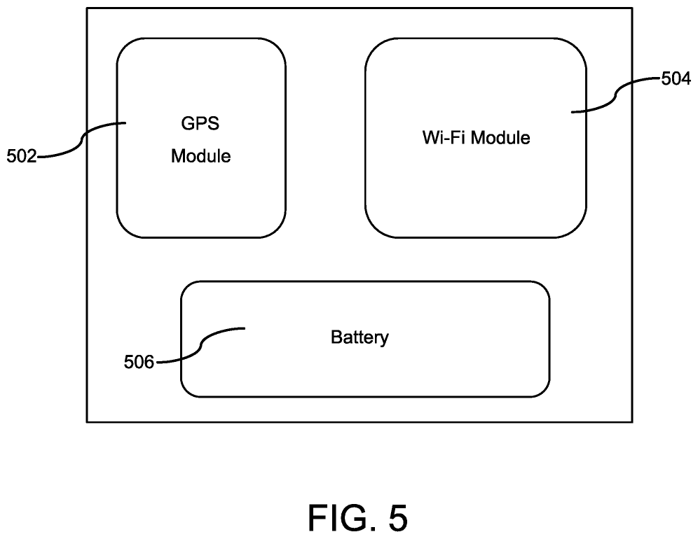

FIG. 5 illustrates a functional block diagram of a GPS transmitter device used at a construction site or work zone on a roadway in accordance with the disclosed architecture. The GPS transmitter device 112 is a physical device which can be of any appropriate size and can be easily placed without any obstruction. The device 112 has a GPS module 502 communication with GPS satellites as described in other embodiments of the present invention. The GPS module 502 can be in the form of a chip or a wireless antenna.

A Wi-Fi module 504 is positioned inside the device 112 allowing the device 112 to function similar to a Wi-Fi access point. The Wi-Fi module 504 may allow the device 112 to be a part of smart city IoT platform. For providing electrical power, the device 112 has a rechargeable battery 506 that can be recharged and replaced with new batteries.

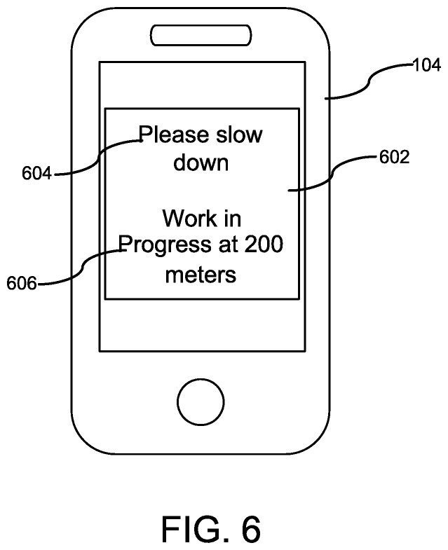

FIG. 6 illustrates a perspective view showing an exemplary push notification displayed on the user device for alerting a driver in accordance with the disclosed architecture. One exemplary embodiment includes a push notification 602 for alerting a driver, however other means such as an SMS, MMS, instant message, a call, or any other means may also be provided by the system for alerting the driver. As illustrated, the push notification 602 includes an alert message 604 “Please slow down” and a reason 606 “Work in progress at 200 meters” for alerting the driver to slow down the vehicle.

In addition to visual notification 602, an audible alert is also provided for allowing the driver to know about an approaching worksite without any distraction. It should be noted that generation of push notifications and audible alerts are in real time as described in FIGS. 2 & 3 and therefore, prevents motorists from speeding through work zones, improving safety for the construction workers and employees inside the work zone. The software application 102 for pushing notifications 602 can work on any type of smartphone model and satellite radio to properly alert drivers of the oncoming work zone.

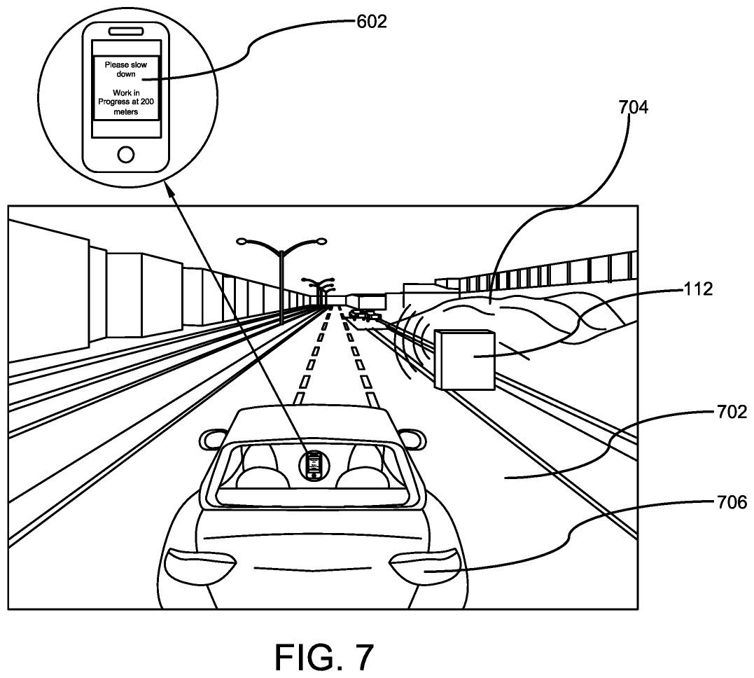

FIG. 7 illustrates a perspective view showing use of the construction site safety system of the present invention in accordance with the disclosed architecture. As illustrated, a GPS transmitter device 112 is positioned on a roadway 702 near a construction site/work zone 704 such that a driver of an approaching vehicle 706 can be alerted by the system. More specifically, Wi-Fi signals and GPS signals are used for determining the distance of the vehicle 706 from the construction site 704 and accordingly, the push notification 602 can be provided. In some embodiments, the push notification 602 may not include the distance, but only an alert to slow down the vehicle 706.

It should be noted that in some embodiments, the notification is displayed and played out both on a handheld electronic device and on a dashboard display of the vehicle 706 for easy accessibility and effectiveness of the alert message.

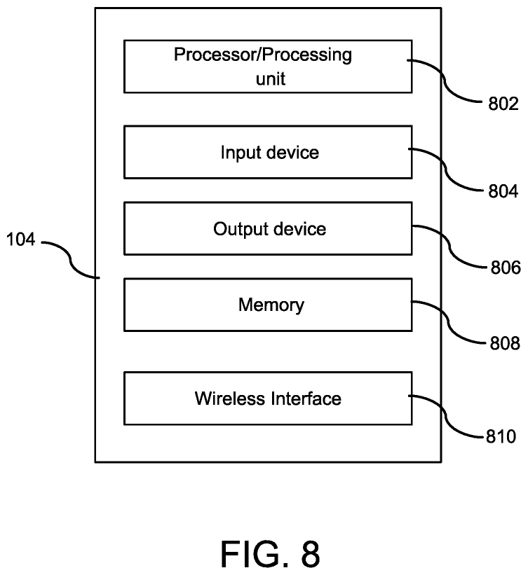

FIG. 8 illustrates components of the exemplary user device 104 for installing the software application 102 in accordance with the disclosed architecture. The processing unit 802 may include suitable logic, instructions, circuitry, interfaces, and/or codes for executing various operations, such as the operations associated with the user device 104, or the like. The processing unit 802 may be configured to control one or more operations executed by the user device 104 in response to the input received at the user device 104 from the user. The processor 802 executes the computer readable instructions stored in the application 102 for displaying a map and push notification. Examples of the processing unit 802 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include or otherwise cover any type of the processing unit 802 including known, related art, and/or later developed processing units. The user device 104 can further include one or more computer executable applications configured to be executed by the processing unit 802. The one or more computer executable applications may include suitable logic, instructions, and/or codes for executing various operations. The one or more computer executable applications may be stored in the memory 808.

The user device 104 includes input device(s) 804 such as a touch input device, voice input device, etc. for entering data and information. Preferably, the touch interface of the user device 104 is used as the input and various buttons/tabs shown on the application 102 are pressed or clicked by the user. The display of the user device 104 also acts as the output device 806 for displaying various contents (e.g., text, images, maps, icons, and/or symbols, etc.) to the user. The display can include a touch screen, and may receive, for example, a touch, a gesture, a proximity, or a hovering input using an electronic pen or a part of a user's body.

Electronic device 104 has memory 808 used for storing programs (sequences of instructions) or data (e.g., program state information) on a temporary or permanent basis for use in the computer system. Memory 808 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 802, in combination with one or more of memory 808, input device(s) 804, output device(s) 806, is utilized to provide users executable instructions on the application 102. The connection to a network is provided by wireless interface 810.

The wireless interface 810 enables the user device 104 to communicate with the other components of the system 100 according to embodiments of the present disclosure. Examples of the communication interface 810 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit.

In some embodiments, the computer readable program code 102 is further configured such that, when it is executed by the processor 802, a speed warning is generated when the vehicle exceeds the speed limit while located within an associated restricted speed zone. A speed warning may be any information relating to the speed limit and associated restricted speed zone. Typically, a speed warning is a notification of a reduced speed limit that is applicable to the restricted speed zone within which the vehicle is located.

As used herein, the term “server system” refers to any computerized component, system, or entity regardless of form which is adapted to provide data, files, applications, content, or other services to one or more other devices or entities on a computer network.

As used herein, the term “user interface” or “graphical user interface” refers to, without limitation, any visual, graphical, tactile, audible, sensory, or other means of providing information to and/or receiving information from a user or other entity.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “roadway safety system”, “construction site safety system”, “safety system”, and “system” are interchangeable and refer to the wireless roadway safety and alert system 100 of the present invention.

Notwithstanding the forgoing, the wireless roadway safety and alert system 100 of the present invention can be of any suitable size and configuration as is known in the art without affecting the overall concept of the invention, provided that it accomplishes the above-stated objectives. One of ordinary skill in the art will appreciate that the wireless roadway safety and alert system 100 as shown in the FIGS. are for illustrative purposes only, and that many other sizes and shapes of the wireless roadway safety and alert system 100 are well within the scope of the present disclosure. Although the dimensions of the wireless roadway safety and alert system 100 are important design parameters for user convenience, the wireless roadway safety and alert system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A roadway safety system for alerting drivers of upcoming work zones and speed restriction areas, the roadway safety system comprising:
a safety system having GPS technology and a computer implemented positioning application for identifying a location of a vehicle and a work zone area being approached by said vehicle;
a push notification is sent on said computer implemented positioning application installed in an electronic device of said vehicle;
wherein said push notification sending an alert to said electronic device of said vehicle; and
further wherein said computer implemented positioning application having a positioning module of said electronic device of said vehicle for determining said location of said vehicle.

2. The roadway safety system of claim 1, wherein said alert includes a first notification of said work zone area.

3. The roadway safety system of claim 2, wherein said computer implemented positioning application having a speed module for determining a speed of said electronic device of said vehicle.

4. The roadway safety system of claim 3, wherein said alert includes a second notification for slowing down a speed of said vehicle.

5. The roadway safety system of claim 4, wherein said electronic device is a handheld device.

6. The roadway safety system of claim 4, wherein said electronic device is a display device on said vehicle.

7. The roadway safety system of claim 6, wherein said display device having a map display indicating a current location of said vehicle.

8. The roadway safety system of claim 7, wherein said location of said display device having coordinates selected from a group consisting of geographic coordinates, longitude/latitude coordinates, and Cartesian coordinates.

9. The roadway safety system of claim 8, wherein said display device receiving location information from a GPS satellite via a communication network.

10. The roadway safety system of claim 9, wherein said communication network is selected from a group consisting of a satellite network, a cellular network, and a public network.

11. The roadway safety system of claim 1 further comprising a plurality of GPS transmitters positioned near said work zone having a positioning module for transmitting a location of said work zone.

12. The roadway safety system of claim 11, wherein said plurality of GPS transmitters determining a distance of an approaching said vehicle to said work zone where said plurality of GPS transmitters are positioned.

13. The roadway safety system of claim 12, wherein said electronic device selected from a group consisting of a wireless laptop, a netbook, a mobile phone, and an automotive display device.

14. A roadway safety system for alerting drivers of upcoming work zones and speed restriction areas, the roadway safety system comprising:
a safety system having GPS technology and a computer implemented positioning application for identifying a location of a vehicle and a work zone area being approached by said vehicle;
a push notification is sent on said computer implemented positioning application installed in an electronic device of said vehicle;
wherein said push notification sending an alert to said electronic device of said vehicle;
a plurality of GPS transmitters positioned near said work zone having a positioning module for transmitting a location of said work zone;
wherein said plurality of GPS transmitters determining a distance of an approaching said vehicle to said work zone where said plurality of GPS transmitters are positioned;
wherein said electronic device selected from a group consisting of a wireless laptop, a netbook, a mobile phone, and an automotive display device;
wherein said computer implemented positioning application having a positioning module of said electronic device of said vehicle for determining said location of said vehicle; and
further wherein said computer implemented positioning application having a speed module for determining a speed of said electronic device of said vehicle.

15. The roadway safety system of claim 14, wherein said alert includes a first notification of said work zone area.

16. The roadway safety system of claim 15, wherein said alert includes a second notification for slowing down a speed of said vehicle.

17. The roadway safety system of claim 16, wherein said electronic device having a map display indicating a current location of said vehicle.

18. A method for alerting drivers of upcoming work zones and speed restriction areas, the method comprising the steps of:
locating a user device in which a computer implemented safety software application is installed, wherein said locating is determined using GPS, radiolocation, or beacon technology, and further wherein said user device is in a vehicle driving on a roadway;
transmitting a location of a roadway work zone with a plurality of GPS transmitter devices on the roadway;
receiving said location of the roadway work zone by said user device;
measuring a real time distance between said user device and said transmitter devices; and
sending a push notification to said safety software application, wherein said push notification includes an alert to reduce a speed of the vehicle.

19. The method of claim 18 further comprising the steps of:
comparing a predetermined threshold distance to said real time distance between said user device and said transmitter devices; and
sending said push notification if said real time distance is less than or equal to said predetermined threshold distance.

20. The method of claim 19 further comprising the steps of:
calculating a speed of said user device;
comparing a predetermined threshold speed to said speed of said user device; and
sending said push notification if said speed of said user device is greater than said predetermined threshold speed.
